(19) United States
(12) Patent Application Publication
(10) Pub. No.: US 2008/0118128 A1
(43) Pub. Date: May 22, 2008

(54) METHODS AND SYSTEMS FOR ENHANCED ACCURACY IMAGE NOISE ADDITION

(76) Inventor: Thomas Louis Toth, Brookfield, WI (US)

Correspondence Address: PATRICK W. RASCHE (12553 - 1000), ARMSTRONG TEASDALE LLP, ONE METROPOLITAN SQUARE, SUITE 2600, ST. LOUIS, MO, 63102-2740, US

(21) Appl. No.: 11/562,157

(22) Filed: Nov. 21, 2006

(51) Int. Cl. G06K 9/00

(52) U.S. Cl. 382/131

(57) ABSTRACT

Methods and apparatus for reconstructing a simulated image of an object that includes a predetermined amount of noise are provided. A method includes receiving a base image, determining an amount of noise in the base image, generating a noise field image based on the determined amount of noise in the base image, combining the noise field image and the base image to generate a simulated image that includes the predetermined amount of noise, and displaying the simulated image.

### BACKGROUND OF THE INVENTION

This invention generally relates to imaging systems and more particularly, to methods and systems for enhancing the accuracy of image noise addition in imaging systems.

At least some known imaging systems use various methods to add noise to images. Such methods are used for radiologist training, protocol development, clinical research to determine how much x-ray dose is really needed for a given clinical problem, and for testing and development of CAD or other image processing algorithms that are sensitive to image noise. These noise addition tools are used because scanning a patient many times at multiple doses is not prudent or ethical due to the detrimental effects of ionizing radiation.

Noise is added to a clinical image to make it look like it was acquired at a lower dose. Such noise addition is typically accomplished by adding noise to the raw image data before the data has been converted into an image because the CT reconstruction process takes the Poisson-distributed quantum noise or x-ray noise that is inherent in the sampled data and distributes it within the image in a way that is unique to computed tomography (CT). However, the raw scan data for CT images is typically large and often discarded after an image is generated. If the raw data is available, to manipulate the data at a later time, the data is usually is installed back onto the scanner to use the same reconstruction engine that was used when generating the patient images.

### BRIEF DESCRIPTION OF THE INVENTION

In one embodiment, a method of reconstructing a simulated image of an object that includes a predetermined amount of noise includes receiving a base image, determining an amount of noise in the base image, generating a noise field image based on the determined amount of noise in the base image, and combining the noise field image and the base image to generate a simulated image that includes the predetermined amount of noise.

In another embodiment, an imaging system includes a processor configured to receive image data relating to a base image and then determine an amount of noise in the base image, generate a noise field image based on the determined amount of noise in the base image, and combine the noise field image and the base image to generate a simulated image that includes a predetermined amount of noise.

In yet another embodiment, a method of adding noise to a base image includes determining an amount of noise associated with the base image, receiving an input of a desired amount of noise to be associated with a simulated image wherein the simulated image is based on the base image, and combining a computer generated random noise field with the base image to form the simulated image such that the noise level in the simulated is substantially equal to the desired amount of noise.

### BRIEF DESCRIPTION OF THE DRAWINGS

FIG. 1 is a pictorial view of a computed tomography (CT) imaging system in accordance with an embodiment of the present invention;

FIG. 2 is a block schematic diagram of the system illustrated in FIG. 1;

FIG. 3 is a flow chart of an exemplary method 300 of reconstructing a simulated image of an object that includes a predetermined amount of noise; and

FIG. 4 is a graph of attenuation projections relative to a determined threshold that may be used with the method shown in FIG. 3.

### DETAILED DESCRIPTION OF THE INVENTION

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. For example, CT imaging apparatus embodiments may be described herein as having a plurality of detector rows that are used in a certain process. Such embodiments are not restricted from having other detector rows that are not used in that process.

Also as used herein, the phrase “reconstructing an image” is not intended to exclude embodiments of the present invention in which data representing an image is generated but a viewable image is not. However, many embodiments generate (or are configured to generate) at least one viewable image.

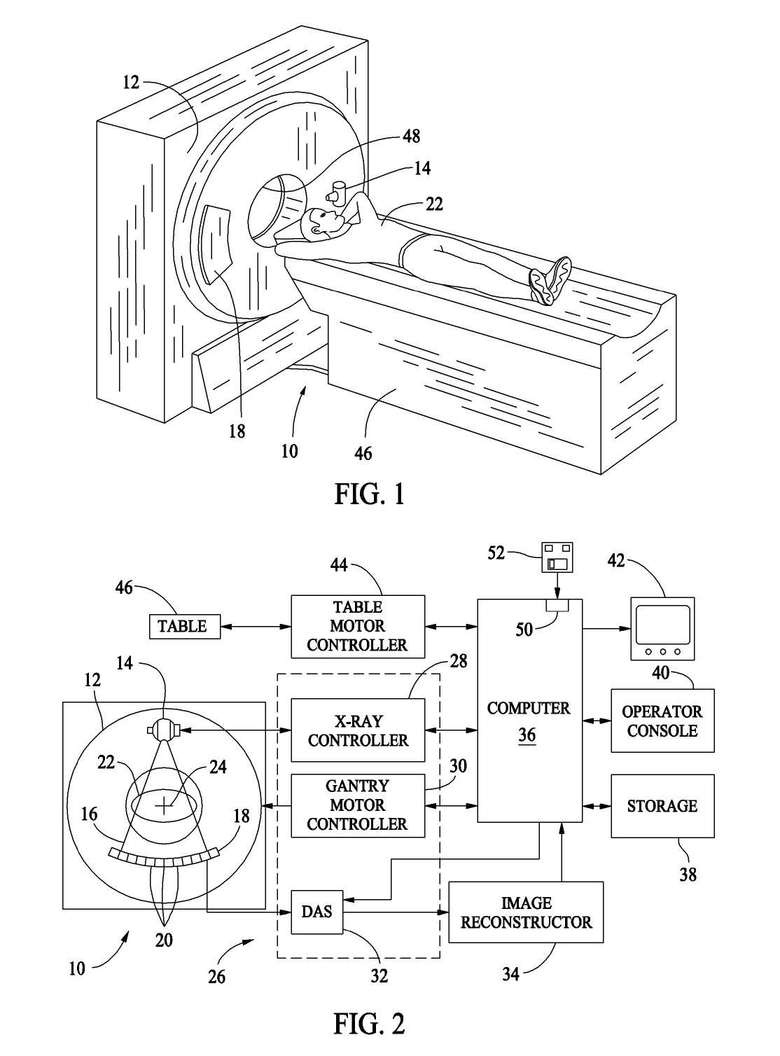

Referring to FIGS. 1 and 2, a multi-slice scanning imaging system, for example, a Computed Tomography (CT) imaging system 10, is shown as including a gantry 12 representative of a “third generation” CT imaging system. Gantry 12 has an x-ray tube 14 (also called x-ray source 14 herein) that projects a beam of x-rays 16 toward a detector array 18 on the opposite side of gantry 12. Detector array 18 is formed by a plurality of detector rows (not shown) including a plurality of detector elements 20 which together sense the projected x-rays that pass through an object, such as a medical patient 22 between array 18 and source 14. Each detector element 20 produces an electrical signal that represents the intensity of an impinging x-ray beam and hence can be used to estimate the attenuation of the beam as it passes through object or patient 22. During a scan to acquire x-ray projection data, gantry 12 and the components mounted therein rotate about a center of rotation 24. FIG. 2 shows only a single row of detector elements 20 (i.e., a detector row). However, multi-slice detector array 18 includes a plurality of parallel detector rows of detector elements 20 such that projection data corresponding to a plurality of quasi-parallel or parallel slices can be acquired simultaneously during a scan.

Rotation of components on gantry 12 and the operation of x-ray source 14 are governed by a control mechanism 26 of CT system 10. Control mechanism 26 includes an x-ray controller 28 that provides power and timing signals to x-ray source 14 and a gantry motor controller 30 that controls the rotational speed and position of components on gantry 12. A data acquisition system (DAS) 32 in control mechanism 26 samples analog data from detector elements 20 and converts the data to digital signals for subsequent processing. An image reconstructor 34 receives sampled and digitized x-ray data from DAS 32 and performs high-speed image reconstruction. The reconstructed image is applied as an input to a computer 36, which stores the image in a storage device 38. Image reconstructor 34 can be specialized hardware or computer programs executing on computer 36.

Computer 36 also receives commands and scanning parameters from an operator via console 40 that has a keyboard. An associated cathode ray tube (CRT), liquid crystal (LCD), plasma, or another suitable display device 42 allows the operator to observe the reconstructed image and other data from computer 36. The operator supplied commands and parameters are used by computer 36 to provide control signals and information to DAS 32, x-ray controller 28, and gantry motor controller 30. In addition, computer 36 operates a table motor controller 44, which controls a motorized table 46 to position patient 22 in gantry 12. Particularly, table 46 moves portions of patient 22 through gantry opening 48.

In one embodiment, computer 36 includes a device 50, for example, a floppy disk drive, CD-ROM drive, DVD drive, magnetic optical disk (MOD) device, or any other digital device including a network connecting device such as an Ethernet device for reading instructions and/or data from a computer-readable medium 52, such as a floppy disk, a CD-ROM, a DVD or another digital source such as a network or the Internet, as well as yet to be developed digital means. In another embodiment, computer 36 executes instructions stored in firmware (not shown). Computer 36 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

It will be understood that the block diagram of FIG. 2 is closer to a logical representation of the functions described herein than a physical block diagram. Particular hardware and/or firmware and/or software implementations of these functions can be left as a design choice to one or more people skilled in the art of logic and/or computational circuit design and/or computer programming upon such person(s) gaining an understanding of the principles of the present invention presented herein.

Although the specific embodiment mentioned above refers to a third generation CT system, the methods described herein equally apply to fourth generation CT systems (stationary detector—rotating x-ray source) and fifth generation CT systems (stationary detector and x-ray source). Additionally, it is contemplated that the benefits of the invention accrue to imaging modalities other than CT. Additionally, although the herein described methods and apparatus are described in a medical setting, it is contemplated that the benefits of the invention accrue to non-medical imaging systems such as those systems typically employed in an industrial setting or a transportation setting, such as, for example, but not limited to, a baggage scanning system for an airport or other transportation center.

In some configurations, detector array 18 is a multirow detector array. Radiation source 14 and multirow ray detector array 18 are mounted on opposing sides of gantry 12 so that both rotate about an axis of rotation. The axis of rotation forms the z-axis of a Cartesian coordinate system having its origin centered within x-ray beam 16. The plane defined by the “x” and “y” axes of this coordinate system thus defines a plane of rotation, specifically the plane of gantry 12.

Rotation of gantry 12 is measured by an angle from arbitrary reference position within plane of gantry 12. The angle varies between 0 and 2π radians. X-ray beam 16 diverges from the gantry plane by an angle θ and diverges along the gantry plane by angle φ. Detector array 18 has a generally arcuate cross-sectional shape and its array of detector elements 20 are arranged to receive and make intensity measurements along the rays of x-ray beam 16 throughout the angles of and of radiation beam 16.

Detector array 18 comprises a 2-D array of detector elements 20 arranged in rows and columns. Each row comprises a plurality of detector elements 20 extending generally along an in-slice dimension. Each column comprises a plurality of detector elements extending generally parallel to the z-axis.

A technical effect of the present invention is determining a base image noise when the base image raw data is unavailable and adding an amount of noise to the base image data to simulate the base image as an image acquired at a lower patient dose.

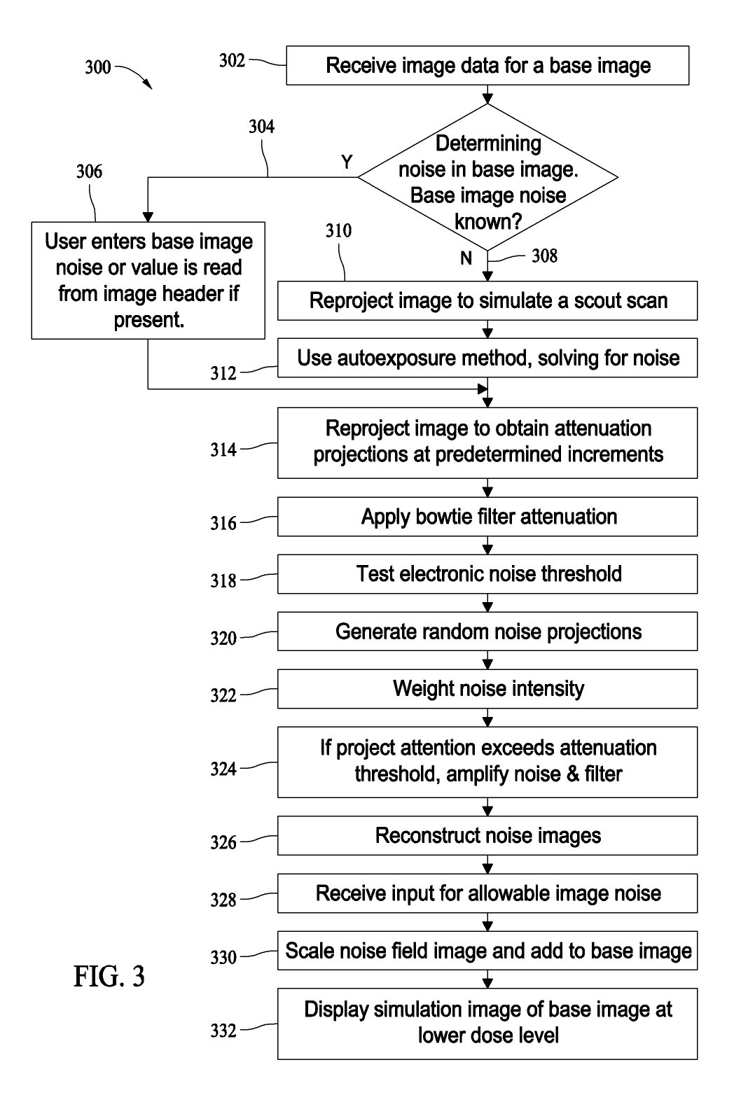

FIG. 3 is a flow chart of an exemplary method 300 of reconstructing a simulated image of an object that includes a predetermined amount of noise. Method 300 includes receiving 302 an image file for a base image. In the exemplary embodiment, the base image is the image that noise will be added to and is typically an image reconstructed from CT scan data of a patient. In some cases, the noise value of the image may be known directly or indirectly such that a computation may be made to ascertain the noise value. If the noise value of the image is known 304, for example, if the base image is a Digital Imaging and Communications in Medicine (DICOM) image the noise value can be entered 306 through operator console 40 or the noise information may be read from the DICOM header. For example, the conditions of operation of the imaging system when the image data was acquired are included in the DICOM header information. In addition to the x-ray tube mA, kVp, scan or exposure time, slice thickness, helical pitch and bowtie filter and other conditions of operation are included in the DICOM header. If the base image noise is not known 308, the base image is analyzed to estimate its noise content by reprojecting 310 the vertical and horizontal axis to obtain projections similar to a scout scan. The image projections are then used in the same methods and equations as the CT autoexposure control which would normally be used to determine the mA needed to obtain a specified image noise for that patient. However, because the mA and other scan parameters are known for example, from the DICOM image header, the auto exposure control equations are solved 312 for the image noise instead of the mA, which is known.

Once the noise associated with the base image is known, (estimated using autoexposure methods or provided by the user or DICOM header), the base image data is reprojected 314 to a set of attenuation projections to model the original scan data from the image. In the exemplary embodiment, the data is reprojected 308 about one degree apart over 180 degrees of rotation. In other embodiments, other reprojection parameters are used.

A bowtie filter attenuation is added 316 to the projections to obtain a total attenuation. The bowtie attenuation can be pre-stored as a table of values or as an appropriate equation because the bowtie filters are part of scanner design, the bowtie attenuation is known. The position of the bowtie relative to the image is adjusted to account for any targeted image offset from the true scanner isocenter. The data is tested 318 to determine a proportion of electronic noise versus quantum noise is attributable to the noise profile. For example, with a small patient or a high mA, electronic noise may be of such a low value that it does not need to be accounted for. However, with a large patient or a low dose scan, electronic noise may become a significant proportion of the noise present in the image data. Each attenuation projection is tested against a threshold to determine if the simulated image noise will be affected by electronic noise contamination (DAS noise threshold). A set of computer-generated normally-distributed random noise projections is then generated 320 that are scaled in accordance with the measured attenuation projections and then back projected to obtain a noise image that represents the noise in the base image.

Accordingly, if the base image was created using autoexposure control at a noise index or standard deviation of, for example, 10 an appropriate amount of noise could be determined such that the image could be viewed at a noise index of any value, for example, 12 or 15. The created projections are used to generate normally distributed noise and to weight 322 the distribution of the noise intensity to create a set of noise projections that would be representative of that image.

W(r,θ)=\sqrt{e^{a(r,θ)}} (1)

Where a(r,0) is the natural log of the reprojected image. The weighting function is used to adjust the noise amplitude of each data sample in accordance with the square root of the number of photons.

The projection attenuations are compared 324 to an attenuation threshold to determine the effect of electronic system noise on the image noise. If the projection attenuation exceeds a determined threshold, the noise is amplified and low-pass filtered to smooth the noise. The noise that was computer-generated and weighted in accordance with the patient's attenuation profile is backprojected to make a noise image which is referred to as a noise field. The noise field includes noise with different intensities of noise in different frequency regions. The noise field includes the same spatial frequencies and intensity distribution as the noise in the original image and is an independent noise set that is scaled so that when added to the base image it results in an image with the desired increased noise.

A user may input 328 a desired noise level for the simulated image to simulate any level of patient dose. The noise level of the noise field is adjusted to yield the desired noise level in the simulated image relative to the existing noise level in the base image. The noise level in the noise field is determined from:

σ_{NF}=\sqrt{σ_{D}²−σ_{B}²}, where (2)

where σ_{NF} represents the noise in the noise field that is to be added to the base image,

σ_{D} represents the desired amount of noise in the simulated image, and

σ_{B} represents the base image noise.

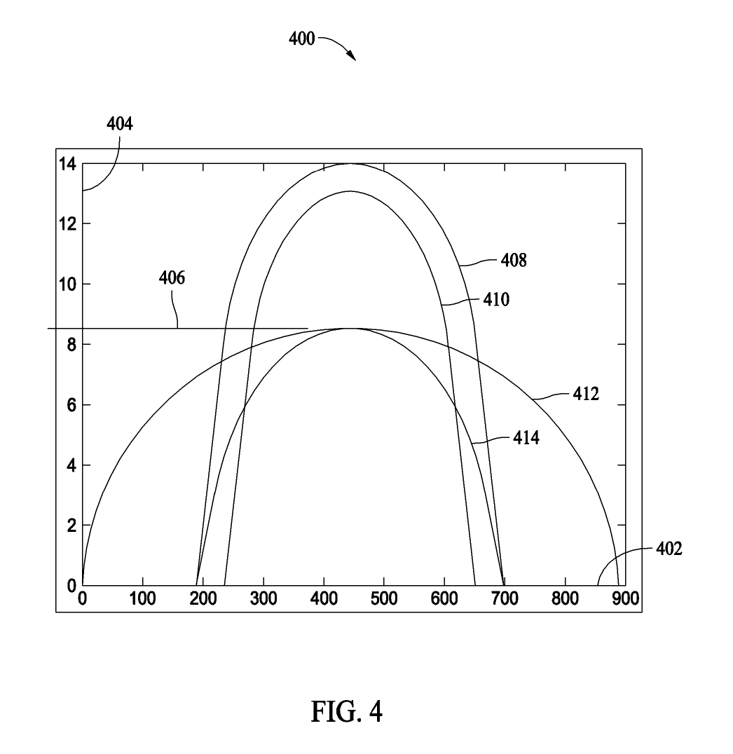

FIG. 4 is a graph 400 of attenuation projections relative to a determined threshold 406 that may be used with method 300 (shown in FIG. 3). Graph 400 includes an x-axis 402 graduated in channel samples (r) and a y-axis 404 graduated in units of attenuation (ln e^{μl(r)}). Each attenuation projection is tested against an attenuation threshold 406 to determine if the simulated image noise will be affected by electronic noise contamination (data acquisition system, DAS noise threshold). Graph 400 includes trace 408 and trace 410 of projection data. Portions of traces 408 and 410 extend above threshold 406. Graph 400 also includes traces 412 and 414 which represent projections with values less than threshold 406. Traces 412 and 414 represent projections that include only x-ray quantum noise whereas traces 408 and 410 represent projections that include electronic data acquisition system noise as well as x-ray quantum noise. The x-ray quantum noise is typically compensated for in the reconstruction algorithm. When the electronic data acquisition system noise becomes a significant portion of the total noise of the image, the electronic data acquisition system noise tends to generate deep streaks in the image. For such projections, special filtering is applied such that the electronic data acquisition system noise is filtered and smoothed out.

At low signal levels, high attenuation causes DAS noise to contaminate the signal and overwhelms the x-ray quantum noise. Generally projection space filters are employed during image reconstruction to minimize the image quality damage. These filters significantly change the characteristic of the image noise for such projection samples. The DAS noise threshold 406 is dependent on the kVp and mA relative to a reference. In the exemplary embodiment, noise threshold 406 is given by:

Adj_threshold=B+ln(Rx_mAs/100 mAs×(Rx_kV/120 Kv)²) (3)

where,

B is the attenuation threshold at the reference conditions (assumed to be 100 mA and 120 kVp in this equation),

Rx_mA represents the actual mA used, and

Rx_Kv represents the actual kV used.

In various embodiments of the present invention B comprises a range of approximately 7 to approximately 10. However, values of B are also used in a range of approximately 5 to approximately 11. If the projections are below the adjusted DAS noise threshold, the projection noise is weighted as a simple function of the projection attenuation using an approximation for the variance of a logarithmic function. Each projection is independently weighted to simulate an xy mA modulation if desired. For those channels that exceed the adjusted DAS noise limit, the random noise intensity is boosted and then filtered in a manner similar to that used in the image reconstruction process. The intensity scaled noise projections are then reconstructed into a set of noise images that represent the noise power spectrum, intensity distribution, and the structure of the noise in the base image. Sets of these noise images can then be randomly combined, scaled and added to the base image to accurately simulate the image as if it were scanned at a lower dose.

After generating the noise for the x-ray quantum noise, any data that exceeds threshold 406 which would be adjusted in accordance with equation (1) and depending on the actual mA and the actual kV used. For example, threshold 406 increases with a greater mA used because the magnitude of the signal levels are high enough that there are well above this electronic noise floor. If however, a lower mA value is used, threshold 406 would be computed at a lesser value than B in equation (3).

For projections that exceed threshold 406 the noise is amplified and filtered to simulate what would happen to noise above threshold 406 when it was back projected into an image again. This method tends to preserve the characteristics of the noise in the simulated image by amplifying the noise and low pass filter the noise to mirror what would have happened to the noise during normal imagery construction to try to mitigate the effects of the electronic data acquisition system noise in the image. If the image generated projections that were below threshold 406, a normal method of scaling the random noise generator to create noise projections that match the attenuation of the patient is used.

The above-described imaging methods and systems are cost-effective and highly reliable. The various embodiments of the present invention provide for noise addition methods that make low dose simulated images more accurately represent actual low dose images. Accordingly, the imaging methods and systems described above facilitate operation of imaging systems in a cost-effective and reliable manner.

While the invention has been described in terms of various specific embodiments, those skilled in the art will recognize that the invention can be practiced with modification within the spirit and scope of the claims.

What is claimed is:

1. A method of reconstructing a simulated image of an object that includes a predetermined amount of noise, said method comprising:
receiving a base image;
determining an amount of noise in the base image;
generating a noise field image based on the determined amount of noise in the base image; and
combining the noise field image and the base image to generate a simulated image that includes the predetermined amount of noise.

2. A method in accordance with claim 1 wherein determining an amount of noise in the base image comprises:
determining at least one image acquisition parameter; and
determining a base image noise level based on the determined at least one image acquisition parameter.

3. A method in accordance with claim 1 wherein the base image comprises a DICOM image and wherein determining an amount of noise in the base image comprises determining the amount of noise in the base image from the base DICOM image and a set of scan parameters associated with the base DICOM image.

4. A method in accordance with claim 1 wherein the base image comprises a DICOM image and wherein determining an amount of noise in the base image comprises determining the conditions of operation used to generate the base image from the DICOM header.

5. A method in accordance with claim 1 wherein determining an amount of noise in the base image comprises reprojecting the base image to generate set of projections that models the original scan data from the image.

6. A method in accordance with claim 1 wherein generating a noise field image based on the determined amount of noise in the base image comprises generating random noise projections based on an attenuation weighting.

7. A method in accordance with claim 1 further comprising modifying the noise projections for xy dose modulation.

8. A method in accordance with claim 1 further comprising reprojecting the base image and adding a bowtie attenuation.

9. A method in accordance with claim 1 further comprising:
determining if a projection attenuation sample exceeds a data acquisition system noise threshold; and
if the projection attenuation sample exceeds a data acquisition system noise threshold, amplifying and low-pass filtering the noise projection sample.

10. An imaging system comprising a processor configured to receive image data relating to a base image and then:
determine an amount of noise in the base image;
generate a noise field image based on the determined amount of noise in the base image; and
combine the noise field image and the base image to generate a simulated image that includes a predetermined amount of noise.

11. A system in accordance with claim 10 wherein said processor is configured to:
determine an image acquisition parameter; and
determine a base image noise level based on the determined image acquisition parameter.

12. A system in accordance with claim 10 wherein the base image comprises a DICOM image and wherein said processor is further configured to determine the amount of noise in the base image from the base DICOM image and a set of scan parameters associated with the base DICOM image.

13. A system in accordance with claim 10 wherein the base image comprises a DICOM image and wherein said processor is further configured to determine a condition of operation of the imaging system used to generate the base image from the DICOM header wherein the condition of operation includes at least one of an x-ray source mA, a kVp, a scan or exposure time, a slice thickness, a helical pitch and a bowtie filter.

14. A system in accordance with claim 10 wherein said processor is further configured to reproject the base image to generate a set of projections that models the original scan data from the image.

15. A system in accordance with claim 10 wherein said processor is further configured to generate random noise projections based on an attenuation weight.

16. A system in accordance with claim 10 wherein said processor is further configured to modify the noise projections for xy dose modulation.

17. A system in accordance with claim 10 wherein said processor is further configured to reproject the base image and add a bowtie attenuation.

18. A system in accordance with claim 10 wherein said processor is further configured to:
determine if a projection attenuation sample exceeds a data acquisition system noise threshold; and
if the projection attenuation sample exceeds a data acquisition system noise threshold, amplify and low-pass filter the noise projection sample.

19. A method of adding noise to a base image comprising:
determining an amount of noise associated with the base image;
receiving an input of a desired amount of noise to be associated with a simulated image wherein the simulated image is based on the base image; and
combining a computer generated random noise field with the base image to form the simulated image such that the noise level in the simulated is substantially equal to the desired amount of noise.

20. A method in accordance with claim 19 wherein determining an amount of noise associated with the base image comprises determining noise in the base image using scan parameters associated with the base image and a reprojection of the base image.
